(19) United States
(12) Patent Application Publication
(10) Pub. No.: US 2026/0022065 A1
(43) Pub. Date: Jan. 22, 2026

(54) COMPOSITE PANELS THAT CONTRACT WHEN HYDRATED

(71) Applicant: Continuus Materials Intellectual Property, LLC, The Woodlands, TX (US)

(72) Inventors: Jack G. Winterowd, The Woodlands, TX (US); Matthew Spencer, The Woodlands, TX (US); Brady Samuelson, The Woodlands, TX (US); Marko Suput, The Woodlands, TX (US); Mya Fisher, The Woodlands, TX (US)

(73) Assignee: Continuus Materials Intellectual Property, LLC, The Woodlands, TX (US)

(21) Appl. No.: 18/776,175

(22) Filed: Jul. 17, 2024

(51) Int. Cl. C04B 16/06; C04B 16/08; C04B 20/00

(52) U.S. Cl. CPC C04B 16/0666; C04B 16/0641; C04B 16/08; C04B 20/0056; C04B 20/0068

(57) ABSTRACT

A method for making a dry composite material that exhibits contraction in one or more dimensions when initially hydrated includes preparing a mixture of dry, compressible, hydrophilic polymer elements and hydrophobic, thermoplastic polymer, forming the mixture into a mat, heating the mat to a temperature that is greater than the melting-point of the hydrophobic, thermoplastic polymer such that the hydrophobic, thermoplastic polymer melts and forms a continuous phase around the compressible hydrophilic polymer elements, molding the hot mat into a desired shape, and cooling the mat to a temperature that is less than the congealing-point of the hydrophobic, thermoplastic polymer.

### BACKGROUND

Typical commercial polymeric or cementitious solid materials that are capable of absorbing water will expand in at least one dimension when hydrated. In general, the expansion occurs as water molecules occupy space between or within polymer molecules or inorganic matrix molecules that constitute the dry material. In order to accommodate the space occupied by the absorbed water molecules, the entire article expands. This results in a swelling action that is nearly universal for all materials that are capable of absorbing water. In the building products industry, the process by which materials expand as they absorb water is commonly known as linear expansion and/or thickness swell. Enormous efforts have been devoted towards identifying cost-effective technologies that can minimize this expansion.

Material types that commonly swell when hydrated include building materials, such as wood, gypsum, fiber/cement, magnesium cement, and other products. These materials can exist in the form of panels, framing members, and other shapes and structures. Typically, these materials are manufactured and transported to a construction site in a dry state. Frequently, these building materials are exposed to rain, high humidity, or flooding. As the building materials absorb water, they exhibit a swelling response. Since the construction process generally involves assembling parts that are intended to have a specific size and shape, wherein the parts fit together in accordance with specific blueprints that are dependent upon the building materials having a specific size and shape, a swelling action in building materials can be problematic. In many cases, a predetermined region of space is dedicated to each component in the building structure. Swollen building materials often exceed the designated space limits. Swollen building materials frequently must be trimmed, sanded, planed, or otherwise re-shaped prior to installation. When the swelling action occurs in building materials that were previously installed, the dimensional expansion can result in buckling or other out-of-plane distortion events. In some cases, these swelling events can necessitate repair work. Accordingly, it may be advantageous to provide a building material that does not expand when exposed to water or even contracts and shrinks in size when exposed to water.

### BRIEF DESCRIPTION OF THE DRAWINGS

FIG. 1A illustrates a method of forming a composite material that contracts when exposed to water, according to some embodiments.

FIG. 1B is a schematic diagram of a composite board formation system, according to some embodiments.

FIG. 2 is an illustration of a dry composite board and a wet composite board, according to some embodiments.

FIGS. 3A-6C are graphs showing changes in the lengths of samples of composite materials based on moisture content, according to some embodiments.

It will be recognized that the figures are schematic representations for purposes of illustration. The figures are provided for the purpose of illustrating one or more implementations with the explicit understanding that the figures will not be used to limit the scope of the meaning of the claims.

### DETAILED DESCRIPTION

The various embodiments disclosed herein provide building materials that contract when exposed to water. These materials provide substantial advantages over typical building materials that swell and expand when exposed to water. For example, attaching new, dry panels to a framing network at predetermined locations or installing new, dry panels onto a large, planar substrate at predetermined locations, wherein the panels would exhibit small amounts of contraction if they were exposed to water in a first exposure event would be useful in several ways. First, the small amount of contraction would also yield a small gap between adjacent panels. Such a gap could accommodate some amount of linear thermal expansion that might occur if the panels were subjected to high temperatures. Further, the initial larger size of the dry panels would also support a practice by which builders could place adjacent panels in direct contact with each other during the installation process without the need for installing with initial gaps between the panels. This would make panel installation much faster and easier. Generally, small amounts of panel contraction in such applications would not be problematic.

The disclosed building materials that exhibit contraction in one or more dimensions as they absorb water may include a composite including a discontinuous phase of dry, compressible, hydrophilic polymer fragments and a continuous phase of hydrophobic, thermoplastic polymer. The compressible, hydrophilic polymer fragments may thus be dispersed in the continuous phase of hydrophobic, thermoplastic polymer material. “Compressible,” as used herein, refers to materials or fragments that become easier to compress when wet. For example, the bulk modulus of the compressible, hydrophilic polymer fragments may be substantially lower when wet than when dry. The continuous phase of hydrophobic, thermoplastic polymer may be in a state of contractive stress. The dry, compressible, hydrophilic polymer fragments may initially inhibit the continuous hydrophobic, thermoplastic polymer phase from contracting to a mechanically neutral configuration. During an initial hydration event, the hydrophilic polymer fragments may become relatively soft and pliable. In this state, the hydrophilic polymer fragments may not be able to mechanically resist the contraction of the hydrophobic, thermoplastic polymer phase. As the hydrophobic, thermoplastic polymer phase contracts, a portion of the contractive stress in this phase may be relieved and the entire composite may experience contraction in one or more dimensions.

Panels, members, or other parts including the disclosed composite can be incorporated into structures, including buildings, wherein panels, framing members, or other parts are installed directly adjacent to one another or other materials in accordance with blueprints or other construction plans or instructions. If the resulting assembly is exposed to water, such as high humidity, rain, flooding, or other, the disclosed composite parts will absorb water, which may soften the compressible, hydrophilic polymer fragments within the hydrophobic, thermoplastic polymer, reducing the ability of the compressible, hydrophilic polymer fragments to resist the contractive stress of the hydrophobic thermoplastic polymer in the composite. As the softened hydrophilic polymer fragments are unable to resist the contractive stress of the hydrophobic polymer continuous phase, the composite will contract in one or more dimensions. This effect can avert the damage, or other adverse effects, that would normally occur with conventional building materials that exhibit linear expansion, or swelling in other dimensions, as they absorb water.

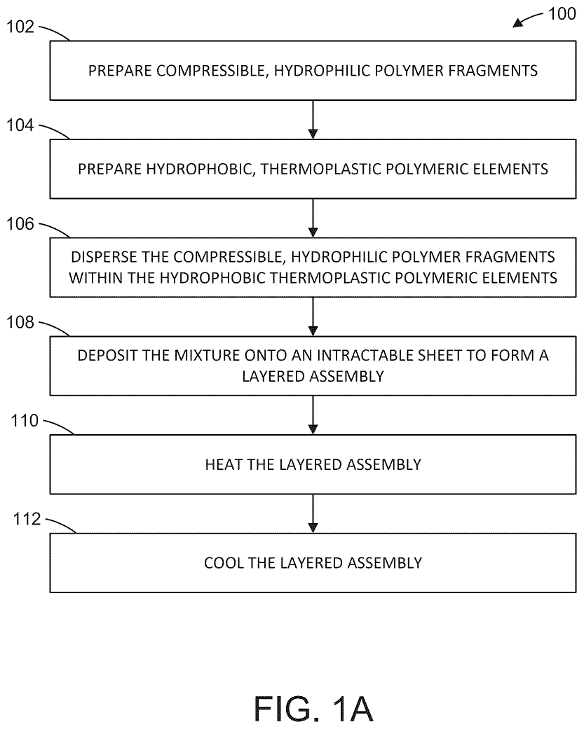

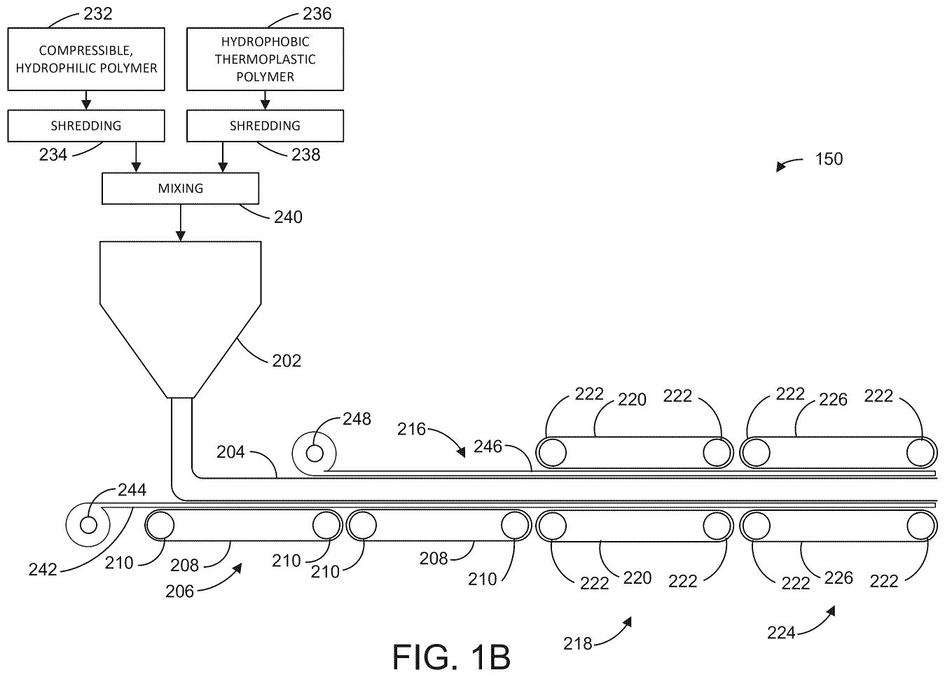

Referring to FIG. 1A, a method 100 of forming a composite material that contracts when exposed to water is shown, according to some embodiments. FIG. 1B shows a composite board formation system 150 that may be used to manufacture composite boards according to the method 100. In operation 102 of the method 100, compressible, hydrophilic polymer fragments are prepared. Operation 102 may include shredding, milling, disintegrating, or otherwise cutting paper, packaging, or compressible, hydrophilic polymer films or slabs in a process that yields fragments or other discrete elements. The fragments may be shaped as irregular plates, with a length and a width that are both larger than the thickness of the fragment. The compressible, hydrophobic fragments may have an average diameter (e.g., a length or width) of about 0.050 inches to about 3.000 inches and a thickness of about 0.005 inches to about 0.150 inches. In some embodiments, hydrophilic polymer fragments can be shaped as films or other articles that have been cut or otherwise converted into a plate-like structure. As shown in FIG. 1A, compressible, hydrophilic polymer material 232 is supplied to a first shredder 234 and shredded to a desired average fragment size.

In some embodiments, rather than fragments, the compressible, hydrophilic polymer used to form the composite material may be in the form of a powder, pellet, bead, particle, filament, fiber, strand, or other type of element. These elements may be substituted for the fragments in the embodiments disclosed herein. Suitable compressible, hydrophilic polymer elements, may have the capacity to absorb water, soften and become more pliable as they hydrate, and be compressible when wet. In some embodiments, the method 100 method 100 may not include operation 102. For example, the compressible, hydrophilic polymer fragments or other elements may be purchased or otherwise procured, rather than being prepared in operation 102.

Hydrophilic polymers used to form composite materials in the embodiments disclosed herein may include polysaccharides, such as cellulose, hemicellulose, starch, pectin, chitin, chitosan and alginic acid. The hydrophilic polymers can also exist as proteins, such as casein. Hydrophilic polymers can be synthetic polymers, such as polyvinyl acetate, polyvinyl alcohol, and acrylic polymers. In some embodiments, hydrophilic polymer fragments can comprise mixtures of two or more hydrophilic polymers, wherein the two or polymers are uniformly mixed, or alternatively, are heterogeneously distributed within the fragment. In some embodiments, the fragments may be made of a single hydrophilic polymer. In other embodiments, a mixture of fragments of different hydrophilic polymers may be used to form the composite material. Materials, including those comprised of hydrophilic polymers, that exist in a solid, non-compressible state after being exposed to water, may not be suitable for use as the compressible, hydrophilic polymer fragments in the present disclosure.

Hydrophilic polymer fragments may have a structure that includes localized regions of low density, or even voids. In some embodiments, hydrophilic polymer fragments may be woven or non-woven materials, including paper, wherein void space exists between adjacent fibers. In some embodiments, hydrophilic polymer fragments may be foams, including open-cell foams. These foams, including open-cell foams, can be prepared by casting aqueous solutions of hydrophilic polymers and foaming agents into films or slabs. In some embodiments, hydrophilic polyurethanes can be prepared with a foamed structure. These materials can then be processed through shredders, mills, disintegrators, or other cutting devices, to yield powders, pellets, beads, particles, filaments, fibers, strands, fragments, or other types of elements.

Suitable hydrophilic polymers for the hydrophilic polymer fragments are capable of absorbing at least 40 percent of their own mass in water and become softer and more pliable as they hydrate. At least one modulus value (e.g., Young's modulus, shear modulus, bulk modulus) of the suitable hydrophilic polymers when wet is less than 50 percent of the corresponding modulus value when dry. Thus, the force required to compress a wet hydrophilic polymer fragment a given amount or distance is less than about 50 percent or less of the force required to compress the fragment the same distance in a dry state. Materials, such as wood or discrete, individual cellulose fibers, including wood pulp fibers, cotton fibers, and rayon fibers, fail to meet these criteria and are not suitable for use in the present disclosure.

In operation 104 of the method 100, hydrophobic, thermoplastic polymeric elements are prepared by shredding, milling, disintegrating, or otherwise cutting films, slabs, waste materials, or other articles that comprise suitable hydrophobic, thermoplastic material. The hydrophobic, thermoplastic polymeric elements may be in the form of particles, pellets, fibers, filaments, or fragments. The hydrophobic, thermoplastic polymeric elements or fragments can be derived from films. In some embodiments, hydrophobic, thermoplastic films can be processed through a shredder, mill, disintegrator, or some other cutting device, to yield fragments. In some embodiments, the films can be sourced from recycling streams or industrial waste streams. Like the compressible, hydrophilic polymer elements, the hydrophobic, thermoplastic polymeric elements may be purchased or otherwise procured rather than prepared. Therefore, the method 100 may not include operation 104. As shown in FIG. 1A, hydrophobic, thermoplastic polymer material 236 is supplied to a second shredder 238 and shredded to a desired average fragment size.

The hydrophobic, thermoplastic polymer may absorb less than 1 percent water and may have a melt-point value in the range of about 80 degrees Celsius to about 170 degrees Celsius. The hydrophobic, thermoplastic polymers may be ductile and may have a coefficient of thermal expansion value that are greater than about

$$2. \times {10}^{- 5} \frac{cm}{° C . cm} .$$

The hydrophobic, thermoplastic polymers may include one or more of low-density polyethylene, medium-density polyethylene, high-density polyethylene, polypropylene, copolymers of ethylene and propylene, thermoplastic polyolefin (TPO), plasticized polyvinylchloride (PVC), styrene-butadiene resins (SBR), and polystyrene resins with low levels of crosslinking.

In operation 106 of the method 100, the compressible, hydrophilic polymer fragments are dispersed within the hydrophobic, thermoplastic polymer to form a mixture. In some embodiments, the compressible, hydrophilic polymer fragments can be combined with hydrophobic polymer elements in a blender, such as a rotary blender, a twin-screw mixer, paddle mixer, ribbon blender, or another type of mixing device that combines both element types at a targeted ratio and blends them together in a manner that achieves a homogenous mixture. In some embodiments, the compressible, hydrophilic polymer fragments can be mixed with molten hydrophobic polymer. For example, the hydrophobic, thermoplastic polymeric elements prepared in operation 104 may be melted, and the compressible, hydrophilic polymer fragments prepared in operation 102 may be mixed into the molten hydrophobic, thermoplastic polymer. In other embodiments, thermoplastic polymer material may be melted without first preparing smaller elements or fragments. As shown in FIG. 1B, the compressible, hydrophilic polymer fragments or elements from the first shredder 234 and the hydrophobic, thermoplastic polymeric fragments or elements from the second shredder 238 are added to a mixer 240 and mixed.

When mixing the compressible, hydrophilic polymer fragments and the hydrophobic, thermoplastic polymer, the volume fraction of the hydrophobic polymer may be about equal to, or greater than, that of the compressible, hydrophilic polymer fragments. In some embodiments, the potentially compressible, hydrophilic polymer fragments may constitute about 10 percent to about 50 percent of the volume fraction of the mixture of compressible, hydrophilic polymer fragments and the hydrophobic, thermoplastic polymer. The volume fraction of a given component can be calculated in the following manner:

$$Volume Fraction of Component 1 = \frac{Component 1 Mass / Component 1 Densi𝔱y}{( Component 1 Mass / Component 1 Densi𝔱y ) + ( Component 2 Mass / Component 2 Densi𝔱y )}$$

In this equation, the density values are those of the solid components alone and are not bulk density values. The mixture of compressible, hydrophilic polymer fragments and hydrophobic, thermoplastic polymer may be immediately subjected to further processing, or can be stored for further processing at a later time.

At operation 108 of the method 100, the mixture of compressible, hydrophilic polymer fragments and hydrophobic, thermoplastic polymer can be deposited onto and formed into a mat on an intractable sheet. As used herein, “intractable” refers to a material that does not dissolve in water and has a melt point above about 350 degrees Celsius. In some embodiments, operation 108 may include placing a second intractable sheet over the mixture of compressible, hydrophilic polymer fragments and hydrophobic, thermoplastic, polymer, such that the mixture of compressible, hydrophilic polymer fragments and hydrophobic, thermoplastic polymer becomes sandwiched between the first and second intractable sheets to form a layered assembly. A plane defined by the longitudinal and width dimensions of the layered assembly may be parallel, or substantially parallel, to that of the intractable sheets. For example, the first intractable sheet may be parallel to or substantially parallel to the second intractable sheet in the layered assembly.

In some embodiments, the intractable sheet may be a roll good and may be unwound onto a conveyor belt, which can transport the intractable sheet beneath a forming station that deposits a mixture of compressible, hydrophilic polymer fragments and hydrophobic, thermoplastic polymer elements onto the intractable sheet at a targeted basis weight. In general, higher basis weight values for the mixture of compressible, hydrophilic polymer fragments and hydrophobic, thermoplastic polymer will result in thicker composite articles. A second roll good of the intractable sheet can then be unwound and placed over the deposited mixture of compressible, hydrophilic polymer fragments and hydrophobic, thermoplastic polymer. For example, as shown in FIG. 1B, the mixer 240 supplies the mixture of compressible, hydrophilic polymer fragments or elements and hydrophobic, thermoplastic polymer fragments or elements to a forming bin 202. The forming bin 202 deposits a mat 204 of the mixture onto a first intractable sheet 242 that unrolls from a first roll 244 onto a first conveyor belt 208 of a conveyor system 206 driven by one or more of the rollers 210. The rollers 210 of the conveyor belts 208 move the first intractable sheet 242 under the forming bin 202 as the mat 204 is deposited. A second intractable sheet 246 unrolls from a second roll 248 onto the mat 204, sandwiching the mat 204 between the two intractable sheets 242, 246 to form a composite sandwich 216.

The intractable sheets may not melt or may have a melt-point that is greater than about 350 degrees Fahrenheit. The intractable sheets may not dissolve or disintegrate when exposed to water. The intractable sheets may be made from at least one of kraft paper, fiberglass nonwoven fabric, and certain polymeric films or polymeric nonwoven fabrics. Polymeric films and fabrics may include cellulose, cellulose acetate, polyester, nylon, polycarbonate, polyetherimide, polyether ether ketone (PEEK), polyaryl ether ketone (PEAK), polyphenylene sulfide (PPS), and polysulfone (PS). The intractable sheet may have a basis weight of about 0.001 pounds per square foot to about 1 pound per square foot.

The mixture of compressible, hydrophilic polymer fragments and hydrophobic, thermoplastic polymer that is deposited on the first intractable sheet may have a basis weight that can range from about 0.2 pounds per square foot to about 10 pounds per square foot.

In some embodiments, a bonding layer, including a thermo-bonding layer, such as a polyethylene film or a polypropylene layer, may be incorporated into the layered assembly between the intractable sheet and the deposited mixture of compressible, hydrophilic polymer fragments and hydrophobic, thermoplastic polymer. The bonding layer may be on the bottom side of the mixture of compressible, hydrophilic polymer fragments and hydrophobic, thermoplastic polymer, the top side of the mixture, or both. In some embodiments, the bonding layer between the intractable sheet on the bottom of the assembly and the mixture of compressible, hydrophilic polymer fragments and hydrophobic, thermoplastic polymer may be different in composition and/or thickness than the bonding layer between the intractable sheet on the bottom of the assembly and the mixture. In some embodiments, both bonding layers have the same composition and/or thickness. In some embodiments, the intractable sheet on the bottom of the assembly may be different in composition and/or basis weight than the intractable sheet on the top of the assembly. In some embodiments, the intractable sheet on the bottom of the assembly may be the same as the intractable sheet on the top of the assembly. In some embodiments, a mat may be formed of a mixture of compressible, hydrophilic polymer fragments and hydrophobic, thermoplastic polymer directly onto a conveyor belt or in a forming box without the use of intractable sheets. In some embodiments, an intractable sheet may be positioned on one side of the mat but not the other. Thus, operation 108 may include forming the mat, but may not include forming the mat on an intractable sheet or positioning a second intractable sheet on top of the mat.

At operation 110 of the method 100, the layered assembly can be heated to a temperature that is sufficiently high to melt the hydrophobic polymer and dehydrate the compressible, hydrophilic polymer fragments. Heating the layered assembly may reduce the moisture content of the compressible, hydrophilic polymer fragments to 1.5 percent or less. The temperature of the layered assembly may be lower than a temperature at which the first or second intractable sheets become melted or thermally degraded (e.g., toasted, shrunk, or mechanically weakened). When the layered assembly is heated, the compressible, hydrophilic polymer fragments may become dispersed within a continuous phase of molten, hydrophobic polymer, which is sandwiched between the top and bottom intractable sheets. Operation 110 may also include molding the heated mat into a desired shape, such as a board with a desired thickness.

Heating of the layered assembly may be accomplished using an oven, a hot-press, or other devices that can effectively heat the layered assembly to a temperature that is greater than that of the melt-point of the hydrophobic, thermoplastic polymer between the intractable sheets, such that the hydrophobic thermoplastic polymer melts and forms a continuous phase around the compressible, hydrophilic polymer elements. Existing composite materials including thermoplastics and cellulosic materials typically use the thermoplastic materials as an adhesive to bind together the cellulosic fragments at discrete points. In the embodiments disclosed herein, there is sufficient hydrophobic thermoplastic polymer to ensure that the core layer includes a discontinuous phase of hydrophilic polymer elements dispered within a continuous phase of hydrophobic thermoplastic polymer. For example, in some embodiments, the mat may include at least 40 percent or at least 45 percent hydrophobic thermoplastic polymer by volume to ensure a continuous phase of hydrophobic thermoplastic polymer in the finished composite. This may ensure that the hydrophobic thermoplastic polymer is in a state of contractive stress such that the finished composite shrinks in size during a first hydration event. Composites that do not include this continuous phase of hydrophobic thermoplastic polymer have not exhibited this contractive stress and do not shrink when exposed to water.

The hot-press can be a single-opening hot-press, a multi-opening hot-press, or a continuous hot-press capable of molding the heated mat into the desired shape. The heating may be of sufficient intensity and duration to convert all, or most, of the hydrophobic, thermoplastic polymer between the intractable sheets into a liquid. When a hot-press is used, the platen temperature can be maintained at a temperature ranging from about 275 degrees Fahrenheit to about 450 degrees Fahrenheit. The pressure applied by the hot-press to the layered assembly may be greater than about 10 psi. Higher platen temperature values, and higher pressure values, may each allow for shorter periods of hot-pressing. The pressure value may be adjusted during the hot-pressing process. The pressure setting can influence the density of the layered assembly during hot-pressing, with higher pressure values generally resulting in a layered assembly with higher density. The pressure applied may not exceed a value at which the compressible, hydrophilic polymer fragments are overly compressed or infused with molten hydrophobic, thermoplastic polymer, which could make the hydrophilic polymer fragments less compressible. In some embodiments, the pressure may be reduced near the end of the pressing process to reduce the likelihood that the compressible, hydrophilic polymer fragments are overly compressed or infused with molten hydrophobic, thermoplastic polymer.

In the example shown in FIG. 1B, the conveyor system 206 moves the composite sandwich 216 to a continuous hot-press 218 with a heated belt 220 traveling around rollers 222. The belt 220 applies heat and pressure to the composite sandwich 216 to melt the hydrophobic polymer in the mat 204. The heating conditions (e.g., the pressure, the temperature, the amount of time the hot-press is applied, etc.) may be sufficient to reduce the moisture content of the compressible, hydrophilic polymer fragments to a range of about 0 percent to about 1.5 percent. If, for example, the initial moisture content of the compressible, hydrophilic polymer fragments was greater than about 5 percent to 6 percent during formation of the layered assembly, venting steps (e.g., periodically releasing the hot press) may be used to facilitate water vapor expulsion from the heated assembly.

At operation 112 of the method 100, the hot, layered assembly is cooled. To accelerate cooling, the hot, layered assembly may be pressed in a cold press. Additionally, or alternatively, a pultrusion process with a cooling zone may be used to cool or help cool the hot, layered assembly. Under the influence of cooling equipment, the molten thermoplastic polymer may begin to cool and eventually congeal. As the solidified hydrophobic polymer cools, it may develop contractive stress. The presence of the compressible, hydrophilic polymer fragments may prevent the hydrophobic, thermoplastic polymer from contracting to a mechanically neutral configuration. The cooling process (e.g., pressing, pultrusion, etc.) may be performed for a period sufficient to cool the thermoplastic polymer to a temperature that is at least 20 degrees Fahrenheit below the congealing point of the thermoplastic polymer. In some embodiments, the cooling process can occur for a period that is sufficient to cool the thermoplastic polymer to a temperature of about 70 degrees Fahrenheit.

In some embodiments, the hot, layered assembly may be transferred from a hot-press or oven into an open cold-press, such as a single-opening cold-press. The cold-press may then be closed, such that the gap between the top and bottom platens of the cold press is approximately equal to a targeted thickness value of the finished composite building material. The temperature of the platens in the cold press may be colder than 20 degrees Fahrenheit below the congealing point of the hydrophobic, thermoplastic polymer. In some embodiments, the temperature of the platens in the cold press are colder than 100 degrees Fahrenheit below the congealing point of the hydrophobic, thermoplastic polymer. In some embodiments, the temperature of the platens in the cold press is less than about 60 degrees Fahrenheit. Colder platen temperature values can allow for shorter periods of cold-press time. In the example shown in FIG. 1B, the conveyor system 206 and the hot-press 218 moves the composite sandwich 216 to a continuous cold-press 224 with a cold belt 226 traveling around rollers 222. The cold 226 applies pressure to the composite sandwich 216 to cool the composite sandwich 216 enough that the hydrophobic polymer in the mat congeals.

The pressure exerted on the layered assembly in the cold press may be large enough to achieve the targeted thickness value in the final composite material but not be so high that the compressible, hydrophilic polymer fragments are overly compressed or infused with molten hydrophobic, thermoplastic polymer. In some embodiments, the pressure exerted on the layered assembly in the cold press is in the range of about 10 psi to about 100 psi. In some embodiments, the pressure exerted on the layered assembly in the cold press is not constant during cold-pressing.

Once cooled, the layered composite may include a continuous phase of hydrophobic, thermoplastic polymer component with a contractive stress, and a discontinuous phase of dry, compressible, hydrophilic polymer fragments that resist compression from the continuous phase. The contractive stress of the continuous phase may be equal to the expansive (or compression-resistant) stress of the discontinuous phase as long as the composite remains dry. However, when the hydrophilic polymer fragments get wet, the contractive stress of the continuous phase of hydrophobic, thermoplastic polymer may overcome the expansive stress of the discontinuous phase of dry, compressible, hydrophilic polymer fragments, causing the layered composite to shrink in at least one dimension. In some embodiments, the method 100 may further include shrinking the composite in at least one dimension by exposing the composite to water for a first time.

Discreet articles of the disclosed composite material (e.g., boards, panels, etc.) may have a first volume associated with the dry composite shortly after production. These same discreet articles may have a second volume associated with the same article subsequent to absorbing water, wherein the second volume is less than that of the first volume.

The disclosed dry composite may be subjected to further processing, such as trimming, cutting, sanding, sealing, marking, painting, inspecting, testing, packaging, and other procedures that are routinely associated with converting primary manufactured materials to finished products, including building products, that are suitable for commercial distribution and construction applications.

Panels, members, or other parts comprising the disclosed composite can be incorporated into structures, including buildings. Panels, framing members, or other parts may be installed directly adjacent to one another or other materials in accordance with blueprints or other construction plans or instructions. If the resulting assembly is subjected to water, such as high humidity, rain, flooding, or other, the disclosed composite parts may absorb water, which will soften the potentially compressible, hydrophilic polymer fragments within the hydrophobic, thermoplastic polymer, which will reduce the ability of the potentially compressible, hydrophilic polymer fragments to resist the contractive stress of the hydrophobic thermoplastic polymer in the composite. As the softened hydrophilic polymer fragments are unable to resist the contractive stress of the hydrophobic polymer continuous phase, the composite will contract in one or more dimensions. This effect can avert the damage, or other adverse effects, that would normally occur with conventional building materials that exhibit linear expansion, or swelling in other dimensions, as they absorb water. As used herein, a “dry” composite refers to a composite wherein the compressible, hydrophilic polymer fragments have a moisture content of 2.0 percent or less, and a “wet” composite refers to a composite wherein the compressible, hydrophilic polymer fragments have a moisture content of more than 6.0 percent.

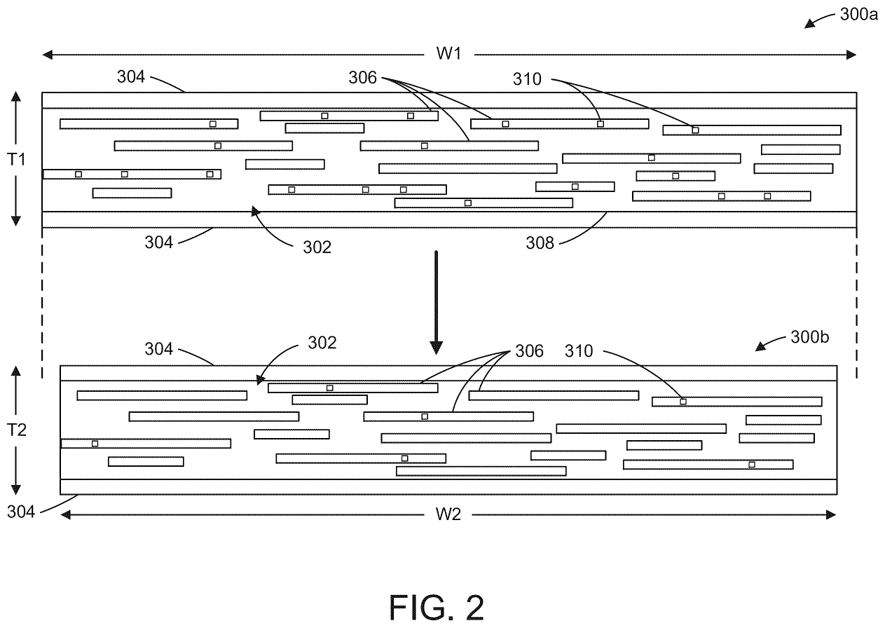

FIG. 2 shows a cross-section of a composite board 300a, 300b manufactured according to the method 100 in a dry condition (300a) and a wet condition (300b), according to some embodiments. In the embodiment shown in FIG. 2, the composite board 300a includes a composite layer 302 sandwiched between two intractable layers 304, which may be laminated to the composite layer 302. The intractable sheets may be made of or may include paper, nonwoven fiberglass, cellulose, cellulose acetate, polyester, nylon, polycarbonate, polyetherimide, polyether ether ketone, polyaryl ether ketone, polyphenylene sulfide, or polysulfone. The composite layer 302 includes compressible, hydrophilic polymer elements 306 dispersed within hydrophobic thermoplastic polymer 308. As described above, the hydrophilic polymer elements 306 may include voids 310 between the fibers of the elements 306 when the composite board 300a is in a dry condition. In some embodiments, the hydrophilic polymer elements 306 may be in the form of or may include a foam. The dry composite board 300a has a width W1 and a thickness T1. When the dry composite board 300a is exposed to moisture, the hydrophilic polymer elements 306 may absorb water and become unable to resist the compressive stress of the hydrophobic thermoplastic polymer 308. The hydrophilic polymer elements 306 may be compressed, and at least some of the voids 310 may collapse. The wet composite board 300b may have a width W2 that is less than the width W1 of the dry composite board 300a and may have a thickness T2 that is less than the thickness T1 of the dry composite board 300a. Though not shown, the length of the board (e.g., into the page as shown in FIG. 2) may also be lower in the wet composite board 300b than in the dry composite board 300a.

The composite board 300a, 300b may include at least 40 percent or at least 45 percent hydrophobic thermoplastic polymer 308 by volume wherein the hydrophobic polymer exists as a continuous phase within the composite and does not function as an adhesive, which only connects hydrophilic elements together at discrete, localized, discontinuous, bond points. The hydrophobic thermoplastic polymer 308 may be or may include at least one of polyethylene, polypropylene, a copolymer of ethylene and propylene, a thermoplastic polyolefin (TPO), plasticized polyvinylchloride (PVC), styrene-butadiene resin (SBR), or polystyrene.

The compressible, hydrophilic polymer elements 306 may have a porous structure and may be capable of absorbing at least 40 percent of their own mass in water and become softer and more pliable as they hydrate. At least one modulus value of the compressible, hydrophilic polymer elements 306 when wet is less than 50 percent of the corresponding modulus value when dry. Thus, the force required to compress a wet compressible, hydrophilic polymer element 306 a given distance is less than about 50 percent of the force required to compress the fragment the same distance in a dry state. The composite board 300a, 300b may thus be configured to contract in one or more dimensions when exposed to water in a first hydration event.

Several composites produced in accordance with embodiment of the method 100 are described in the examples below.

### Example 1

In a first example, a composite that exhibited contraction in the longitudinal dimension when hydrated in high humidity was prepared on a laboratory scale.

400 pounds of gable top milk cartons with a composition of 82 percent paper and 18 percent polyethylene were processed through an industrial shredder with a screen size of ⅝ inch to yield carton fragments, the paper components of which made up the hydrophilic polymer fragments. The thickness of the carton fragments was 0.003 inches. The length and width of the carton fragments were about 0.5 inches to about 1.0 inches. One side of each fragment was made of polyethylene, while the other side was made of paper. Separately, 400 pounds of polyethylene film were processed through an industrial shredder with a screen size of ⅝ inch to yield plastic fragments (i.e., hydrophobic, thermoplastic polymer fragments). The thickness of each of the polyethylene fragments was 0.003 inches. The length and width of each of the polyethylene plastic fragments were about 0.25 inches to about 1.0 inches.

Carton fragments (5,185 grams on a dry basis) and plastic fragments (3,315 grams on a dry basis) were loaded into a lab-scale paddle blender (17.75-inch diameter×24-inch depth×29.5-inch width). The blender was operated at a speed of about 15-20 rpm for a period of 2 minutes to yield a homogenous mixture of the two different fragment types. The mixture of the two different carton fragments and plastic fragments had a composition that was approximately 4 percent water, 48 percent paper, and 48 percent polyethylene.

A layered assembly was then prepared as described below. First, a steel caul sheet (22-inch length×17-inch width×⅛-inch thickness) was placed on a table surface. Teflon release film (22-inch length×17-inch width) was placed on top of the steel caul sheet. Kraft paper (22-inch length×16-inch width) was placed on top of the release film. The machine direction of the kraft paper was parallel to the 22-inch length of the caul sheet. Polyethylene film (0.003-inch thickness×22-inch length×16-inch width) was placed on top of the kraft paper. A forming box (with no top or bottom) with interior dimensions of 20-inch length×14-inch width×4-inch height was placed on top of the polyethylene film and was centered over the caul sheet. The forming box was filled with a portion of the blended fragments (1,900 grams on an as-is basis). The fragment material was distributed uniformly in the forming box and was manually compressed using a flat board (19.75-inch length×13.75-inch width×0.75-inch thickness) with a handle on the top side. The forming box was carefully removed without significantly damaging the integrity of the mat. Another layer of polyethylene film (0.003-inch thickness×22-inch length×16-inch width) was placed on top of the fragment layer. A nonwoven fiberglass fabric (22-inch length×16-inch width) was placed on top of the polyethylene film. The machine direction of the fiberglass fabric was parallel to the 22-inch length of the mat. Another layer of Teflon film (22-inch length×16-inch width) was placed on top of the fiberglass fabric. Another steel caul sheet (22-inch length×17-inch width×⅛-inch thickness) was placed over the Teflon film.

A lab-scale hot-press with 24-inch×20-inch platens was preheated to a temperature of 410 degrees Fahrenheit. The assembly was placed on the bottom platen and the press was immediately closed such that the top platen contacted the assembly over a period of about 15 seconds. The ram force exerted on the assembly was about 4,000 lb. after a press closing period of about 30 seconds. The assembly was pressed under these conditions for an additional period of 435 seconds. The hot-press was then opened, and the assembly was rapidly removed from the hot-press and transferred into a cold-press with chiller fluid at a temperature of 45 degrees Fahrenheit. The ram force exerted on the assembly in the cold-press was 8,000 lb. The assembly was cold-pressed under these conditions for an additional period of 465 seconds. The core temperature of the assembly was less than 194 degrees Fahrenheit at the end of the cold-pressing step.

A composite material was isolated from the assembly between the layers of Teflon film. The composite material was trimmed to a length of 16 inches and a width of 12 inches. The thickness of the composite was about 0.44 inches. The density of the composite material was about 58 pounds per cubic foot.

Five replicate composite panels were prepared in this manner. A single test specimen (11.8-inch length×3.0-inch width) was isolated from each of the five composite panels. The resulting specimens, labeled G11-G15 in Tables 1 and 2 below, were initially conditioned in a lab-scale climate simulation chamber at a temperature of 70 degrees Fahrenheit and a relative humidity of 50 percent for a period required to reach equilibrium. The mass and length of each specimen were then measured. Any warpage in the test specimens was eliminated by clamping the specimens to a flat substrate just prior to each length measurement. Specimens G11-G15 were then returned to the climate simulation chamber and the conditions were adjusted to a temperature of 70 degrees Fahrenheit and a relative humidity of 90 percent. Specimens G11-G15 were periodically removed from the climate simulation chamber, and the mass and length of each specimen were measured at a temperature of 70 degrees Fahrenheit. This process was conducted over a period of 384 hours. Specimens G11-G15 were then dried in an oven at a temperature of 230 degrees Fahrenheit for a period of 69 hours and a dry mass value was obtained, which allowed for the calculation of moisture content values throughout the conditioning process. Table 1 below shows the mass measurements for specimens G11-G15 at various times in the humidification process, as well as after the drying process. Table 2 below shows the length measurements for specimens G11-G15 at various times in the humidification process.

TABLE 1

| Conditioning | G11 | G12 | G13 | G14 | G15 |
|---|---|---|---|---|---|
| Time (h) @ 90% R.H. | Mass (g) | Mass (g) | Mass (g) | Mass (g) | Mass (g) |
| Dry | 220.28 | 214.56 | 236.10 | 226.28 | 229.48 |
| 0 | 227.12 | 220.51 | 242.80 | 232.81 | 235.44 |
| 4 | 228.36 | 221.64 | 243.97 | 233.90 | 236.48 |
| 24 | 229.89 | 222.84 | 245.42 | 235.52 | 237.84 |
| 48 | 230.82 | 223.59 | 246.26 | 236.43 | 238.64 |
| 168 | 233.56 | 225.88 | 248.85 | 239.00 | 240.96 |
| 192 | 233.86 | 226.11 | 249.15 | 239.37 | 241.25 |
| 216 | 234.16 | 226.40 | 249.53 | 239.75 | 241.51 |
| 240 | 234.09 | 226.25 | 249.30 | 239.59 | 241.54 |
| 264 | 234.11 | 226.35 | 249.49 | 239.74 | 241.69 |
| 288 | 234.49 | 226.86 | 250.04 | 240.28 | 242.16 |
| 336 | 234.68 | 227.11 | 250.25 | 240.47 | 242.45 |
| 384 | 234.83 | 227.21 | 250.48 | 240.69 | 242.58 |

TABLE 2

| Conditioning | G11 Length | G12 Length | G13 Length | G14 Length | G15 Length |
|---|---|---|---|---|---|
| Time (h) | (inch) | (inch) | (inch) | (inch) | (inch) |
| 0 | 11.7888 | 11.7633 | 11.8085 | 11.7832 | 11.7893 |
| 4 | 11.7908 | 11.7655 | 11.8045 | 11.7828 | 11.7877 |
| 24 | 11.7860 | 11.7645 | 11.8025 | 11.7798 | 11.7840 |
| 48 | 11.7838 | 11.7610 | 11.8002 | 11.7758 | 11.7815 |
| 168 | 11.7828 | 11.7592 | 11.7995 | 11.7725 | 11.7790 |
| 192 | 11.7828 | 11.7602 | 11.7957 | 11.7713 | 11.7815 |
| 216 | 11.7798 | 11.7548 | 11.7968 | 11.7713 | 11.7753 |
| 240 | 11.7785 | 11.7530 | 11.7937 | 11.7687 | 11.7757 |
| 264 | 11.7725 | 11.7510 | 11.7928 | 11.7680 | 11.7745 |
| 288 | 11.7755 | 11.7510 | 11.7932 | 11.7648 | 11.7725 |
| 336 | 11.7745 | 11.7498 | 11.7922 | 11.7628 | 11.7727 |
| 384 | 11.7727 | 11.7495 | 11.7923 | 11.7640 | 11.7715 |

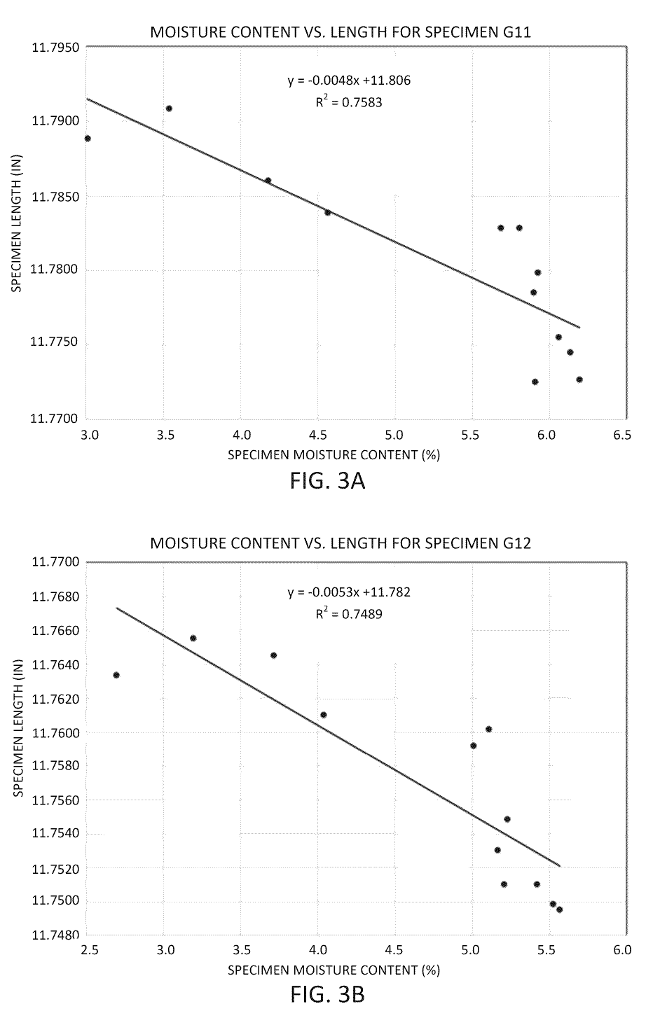

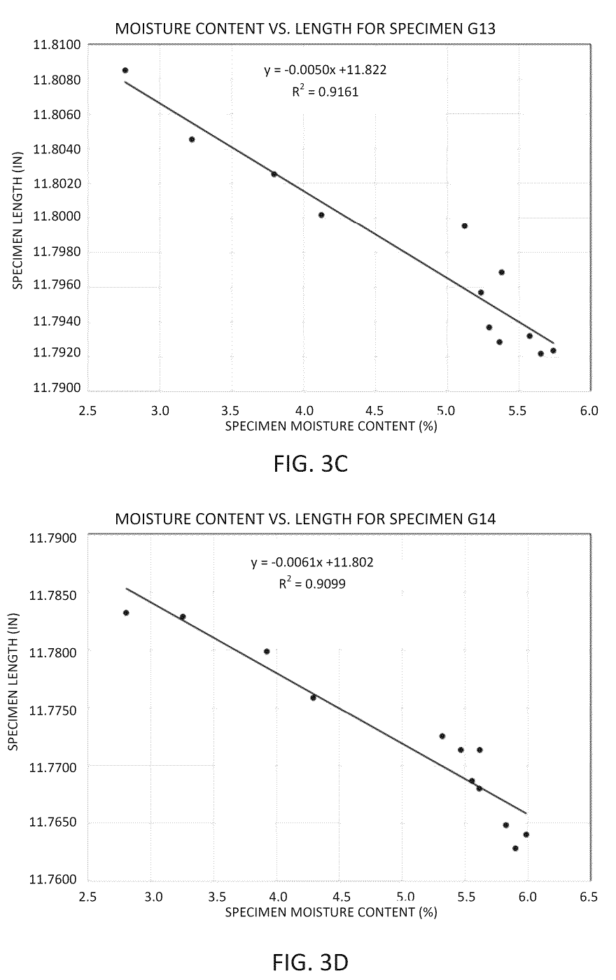

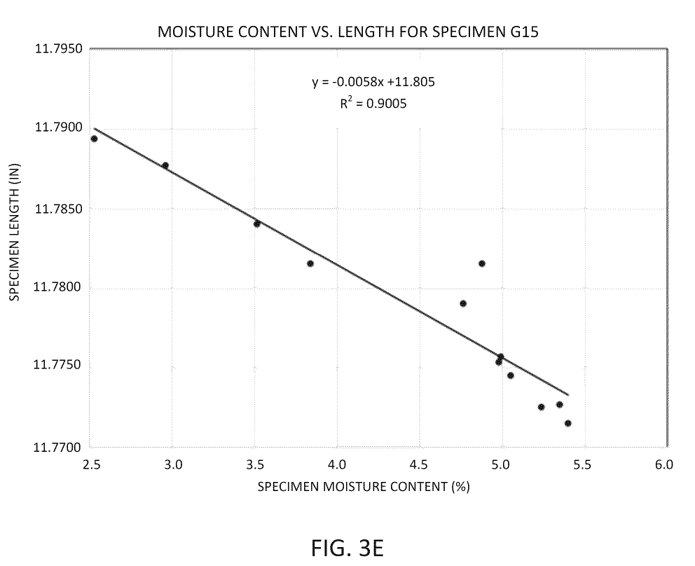

The moisture content of each specimen at each measurement was calculated by dividing the difference between the dry mass of the specimen and the measured mass at each time by the measured mass of the specimen. FIGS. 3A-3E are plots of the measured specimen length versus the determined moisture content at the same point in the humidification process for Specimens G11-G15, respectively. As can be seen in FIGS. 3A-3E, the length measurement decreases with increasing moisture content. Thus, unlike typical building materials that swell when exposed to moisture, each of specimens G11-G15 reduced in length as the hydrophilic polymer fragments absorbed moisture and increasingly failed to resist the compressive stress in the hydrophobic, thermoplastic polymer elements. The relationship was similar for all of specimens G11-G15, with the length decreasing by about 0.0048 inches to about 0.0061 inches per percent moisture increase.

### Example 2

In a second example, similar specimens to those produced in Example 1 in a process substantially the same as that described with regard to Example 1, were prepared, except as noted herein. In this second example, 4,146 grams on a dry basis of 82 percent paper and 18 percent polyethylene carton fragments were mixed with 4,354 grams on a dry basis of polyethylene plastic fragments, yielding a mixture containing approximately 3 percent water, 39 percent paper, and 58 percent polyethylene. This mixture was formed into a layered assembly with kraft paper and polyethylene film as described above. The hot-press, with platens heated to about 400 degrees Fahrenheit, applied a ram force of 2,000 pounds after a press-closing period of 30 seconds to the layered assembly. The assembly was pressed under these conditions for an additional period of 435 seconds. Following the hot pressing, a cold press with chiller fluid at approximately 45 degrees Fahrenheit applied a ram force of about 8,000 pounds to the layered assembly for about 465 seconds, reducing the core temperature of the layered assembly to about 194 degrees and pressing the layered assembly to a thickness to about 0.43 inches and a density of about 58 pounds per cubic foot.

Five replicate composite panels were prepared in this manner. A single test specimen (11.8-inch length×3.0-inch width) was isolated from each of the five composite panels. The resulting specimens, labeled G16-G20 in Tables 3 and 4 below, were humidified over a period of 384 hours, with the mass and length of the specimens measured periodically. Table 3 below shows the mass measurements for specimens G16-G20 at various times in the humidification process, as well as after the drying process. Table 4 below shows the length measurements for specimens G16-G20 at various times in the humidification process.

TABLE 3

| Conditioning | G16 | G17 | G18 | G19 | G20 |
|---|---|---|---|---|---|
| Time (h) @ 90% R.H. | Mass (g) | Mass (g) | Mass (g) | Mass (g) | Mass (g) |
| Dry | 228.50 | 235.01 | 234.55 | 234.33 | 232.07 |
| 0 | 233.54 | 239.45 | 239.43 | 239.11 | 236.62 |
| 4 | 234.41 | 240.34 | 240.31 | 240.05 | 237.23 |
| 24 | 235.59 | 241.29 | 241.51 | 241.17 | 238.55 |
| 48 | 236.20 | 241.84 | 242.09 | 241.80 | 239.14 |
| 168 | 238.01 | 243.28 | 243.80 | 243.43 | 240.72 |
| 192 | 238.21 | 243.44 | 244.03 | 243.66 | 240.91 |
| 216 | 238.44 | 243.73 | 244.40 | 244.02 | 241.43 |
| 240 | 238.35 | 243.48 | 244.13 | 243.68 | 241.12 |
| 264 | 238.36 | 243.57 | 244.32 | 243.85 | 241.22 |
| 288 | 238.82 | 243.95 | 244.60 | 244.18 | 241.52 |
| 336 | 238.97 | 244.08 | 244.82 | 244.35 | 241.67 |
| 384 | 239.13 | 244.20 | 244.90 | 244.47 | 241.80 |

TABLE 4

| Conditioning | G16 Length | G17 Length | G18 Length | G19 Length | G20 Length |
|---|---|---|---|---|---|
| Time (h) | (inch) | (inch) | (inch) | (inch) | (inch) |
| 0 | 11.7758 | 11.7710 | 11.7773 | 11.7757 | 11.7752 |
| 4 | 11.7773 | 11.7718 | 11.7760 | 11.7767 | 11.7808 |
| 24 | 11.7717 | 11.7685 | 11.7710 | 11.7725 | 11.7722 |
| 48 | 11.7677 | 11.7658 | 11.7667 | 11.7695 | 11.7688 |
| 168 | 11.7632 | 11.7623 | 11.7635 | 11.7652 | 11.7650 |
| 192 | 11.7613 | 11.7615 | 11.7632 | 11.7652 | 11.7652 |
| 216 | 11.7605 | 11.7612 | 11.7610 | 11.7638 | 11.7628 |
| 240 | 11.7598 | 11.7590 | 11.7598 | 11.7633 | 11.7617 |
| 264 | 11.7583 | 11.7580 | 11.7587 | 11.7617 | 11.7602 |
| 288 | 11.7550 | 11.7575 | 11.7578 | 11.7602 | 11.7587 |
| 336 | 11.7555 | 11.7565 | 11.7575 | 11.7597 | 11.7590 |
| 384 | 11.7553 | 11.7545 | 11.7557 | 11.7593 | 11.7567 |

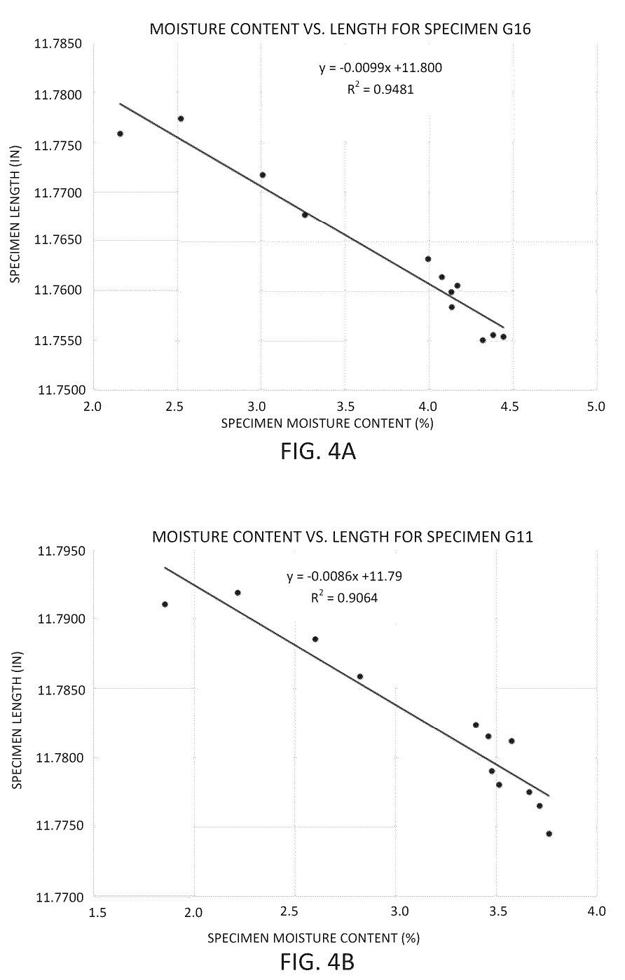

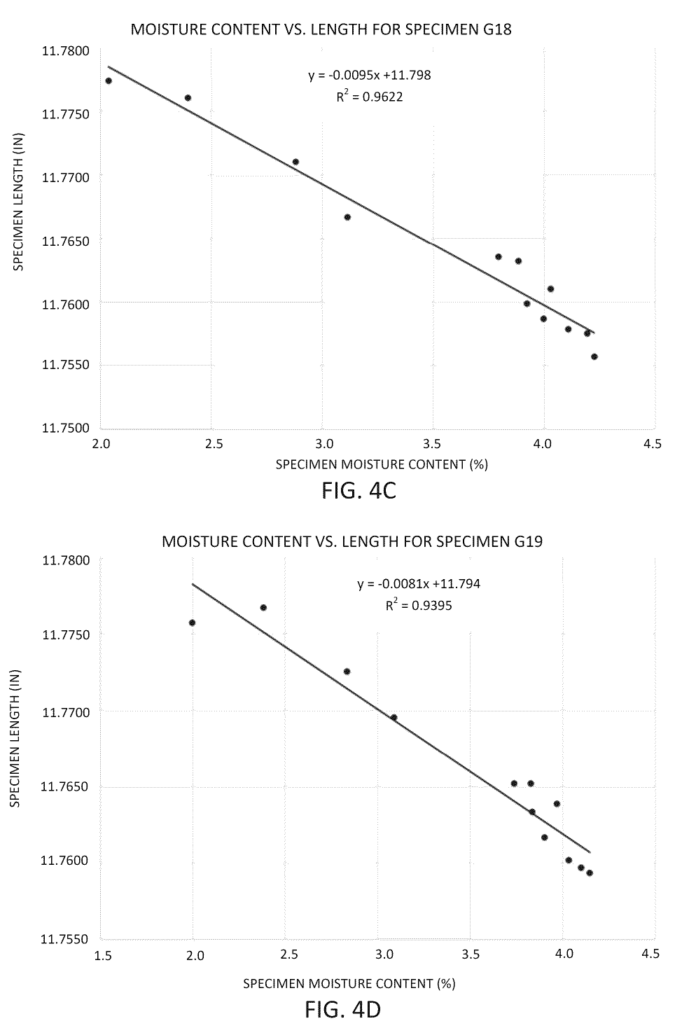

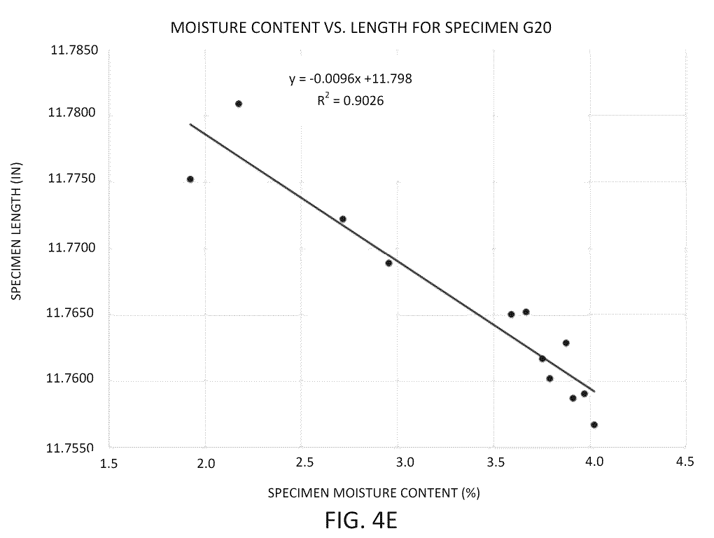

As described above, the moisture content of each specimen at each measurement was calculated by dividing the difference between the dry mass of the specimen and the measured mass at each time by the measured mass of the specimen. FIGS. 4A-4E are plots of the measured specimen length versus the determined moisture content at the same point in the humidification process for Specimens G16-G20, respectively. As can be seen in FIGS. 4A-4E, the length measurement decreases with increasing moisture content. Thus, unlike typical building materials that swell when exposed to moisture, each of specimens G16-G20 reduced in length as the hydrophilic polymer fragments absorbed moisture and increasingly failed to resist the compressive stress in the hydrophobic, thermoplastic polymer elements. The relationship was similar for all of specimens G16-G20, with the length decreasing by about 0.0081 inches to about 0.0099 inches per percent moisture increase. Thus, compared to test specimens in Example 1, the specimens in Example 2 had a higher level of hydrophobic, thermoplastic polymer in the core of the assembly (58 percent compared to 48 percent in Example 1) and exhibited greater levels of length contraction per unit of moisture content increase.

### Example 3

In a third example, similar specimens to those produced in Examples 1 and 2 were prepared in a process substantially the same as that described with regard to Examples 1 and 2, except as noted herein. In this third example, aseptic cartons made from 74 percent paper, 4 percent aluminum, and 22 percent polyethylene were shredded as a source of hydrophilic polymer fragments rather than the gable top milk cartons used in Examples 1 and 2. The thickness of the carton fragments was about 0.021 inches. The length and width of the carton fragments were about 0.5 inches to about 1.0 inches. Both major surfaces of each fragment were comprised of polyethylene, with paper therebetween. Polyethylene film was separately processed through an industrial shredder with a screen size of ⅝ inch to yield hydrophobic, thermoplastic polymer fragments. The thickness of each of the polyethylene fragments was about 0.003 inches. The length and width of each of the polyethylene fragments were about 0.25 inches to about 1.0 inches.

2,188 grams on a dry basis of carton fragments and 1,312 grams on a dry basis of polyethylene fragments were mixed, yielding a mixture containing approximately 2 percent water, 2 percent aluminum, 46 percent paper, and 50 percent polyethylene.

A layered assembly was assembled, similar to the layered assembly of Examples 1 and 2, with the 980 grams of mixture forming the center layer. A hot-press, with platens heated to about 400 degrees Fahrenheit, applied a ram force of 4,000 pounds after a press-closing period of 30 seconds to the layered assembly. The assembly was pressed under these conditions for an additional period of 225 seconds. Following the hot pressing, a cold press with chiller fluid at approximately 45 degrees Fahrenheit applied a ram force of about 4,000 pounds to the layered assembly for about 225 seconds, reducing the core temperature of the layered assembly to about 194 degrees and pressing the layered assembly to a thickness to about 0.25 inches and a density of about 59 pounds per cubic foot.

Three replicate composite panels were prepared in this manner. A single test specimen (11.8-inch length×3.0-inch width) was isolated from each of the three composite panels. The resulting specimens, labeled K7-K9 in Tables 5 and 6 below, were humidified over a period of 744 hours, with the mass and length of the specimens measured periodically. Table 5 below shows the mass measurements for Specimens K7-K9 at various times in the humidification process, as well as after the drying process. Table 6 below shows the length measurements for Specimens K7-K9 at various times in the humidification process.

TABLE 5

| Conditioning | K7 | K8 | K9 |
|---|---|---|---|
| Time (h) @ 90% R.H. | Mass (g) | Mass (g) | Mass (g) |
| Dry | 139.8 | 131.5 | 145.8 |
| 0 | 143.4 | 135.0 | 149.4 |
| 4 | 144.5 | 135.9 | 150.5 |
| 24 | 145.3 | 136.8 | 151.3 |
| 48 | 145.9 | 137.4 | 151.8 |
| 168 | 147.4 | 139.0 | 153.2 |
| 192 | 147.5 | 139.1 | 153.5 |
| 216 | 147.7 | 139.3 | 153.5 |
| 336 | 148.5 | 139.9 | 154.6 |
| 384 | 148.9 | 140.3 | 155.0 |
| 744 | 149.8 | 140.9 | 156.0 |

TABLE 6

| Conditioning | K7 Length | K8 Length | K9 Length |
|---|---|---|---|
| Time (h) @ 90% R.H. | (inch) | (inch) | (inch) |
| 0 | 11.8822 | 11.8550 | 11.8470 |
| 4 | 11.8742 | 11.8505 | 11.8442 |
| 24 | 11.8702 | 11.8587 | 11.8423 |
| 48 | 11.8707 | 11.8628 | 11.8400 |
| 168 | 11.8698 | 11.8560 | 11.8387 |
| 192 | 11.8687 | 11.8545 | 11.8392 |
| 216 | 11.8672 | 11.8545 | 11.8398 |
| 336 | 11.8670 | 11.8517 | 11.8345 |
| 384 | 11.8650 | 11.8508 | 11.8347 |
| 744 | 11.8610 | 11.8373 | 11.8353 |

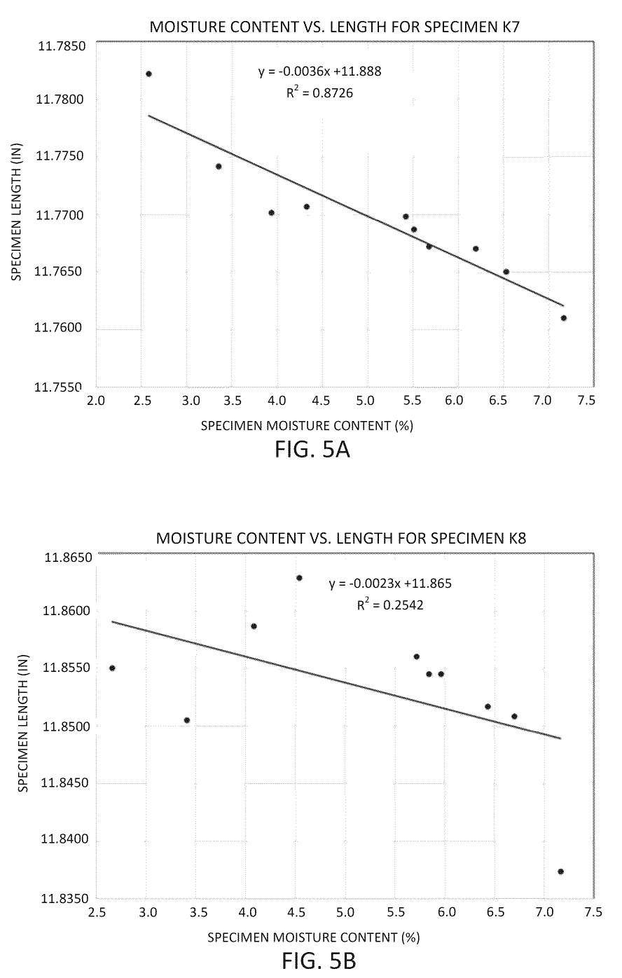

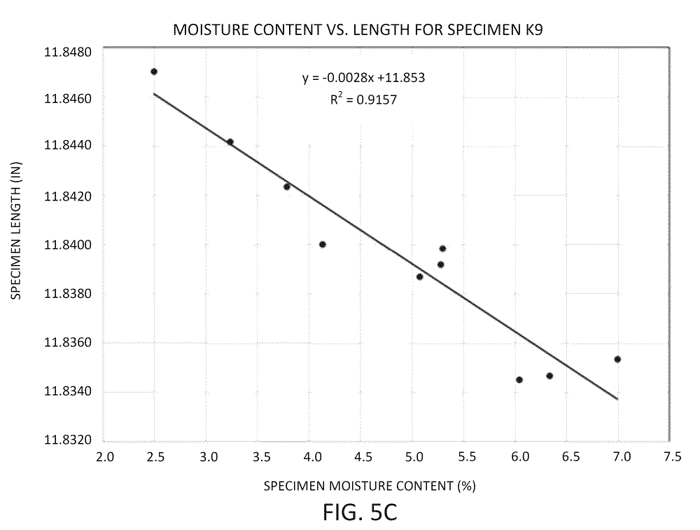

As described above, the moisture content of each specimen at each measurement was calculated by dividing the difference between the dry mass of the specimen and the measured mass at each time by the measured mass of the specimen. FIGS. 5A-5C are plots of the measured specimen length versus the determined moisture content at the same point in the humidification process for specimens K7-K9, respectively. As can be seen in FIGS. 5A-5C, the length measurement decreases with increasing moisture content. Thus, unlike typical building materials that swell when exposed to moisture, each of specimens 5A-5C reduced in length as the hydrophilic polymer fragments absorbed moisture and increasingly failed to resist the compressive stress in the hydrophobic, thermoplastic polymer elements. The relationship was similar for specimens K7 and K9, though less pronounced for specimen K8. The average relationship between moisture percentage and length in specimens K7-K9 had length decreasing by about 0.0032 inches per percent moisture increase. Thus, specimens K7-K9 exhibited lower levels of length contraction per unit of moisture content increase than the specimens examined in Examples 1 and 2.

### Example 4

In a fourth example, similar specimens to those produced in Examples 1-3 were prepared in a process substantially the same as that described with regard to Examples 1-3, except as noted herein. In this third example, kraft paper with a basis weight of about 42 pounds per 1000 square feet was shredded as a source of hydrophilic polymer fragments rather than the gable top milk cartons used in Examples 1 and 2 or the aseptic cartons used in Example 3. The thickness of the kraft paper fragments was about 0.010 inches. The length and width of the carton fragments were about 0.5 inches to about 1.5 inches. Polyethylene film was separately processed through an industrial shredder with a screen size of ⅝ inch to yield hydrophobic, thermoplastic polymer fragments. The thickness of each of the polyethylene fragments was about 0.003 inches. The length and width of each of the polyethylene fragments were about 0.25 inches to about 1.0 inches.

1,750 grams on a dry basis of kraft paper fragments and 1,750 grams on a dry basis of polyethylene fragments were mixed, yielding a mixture containing approximately 3 percent water, 48.5 percent paper, and 48.5 percent polyethylene.

A layered assembly was assembled, similar to the layered assembly of Examples 1-3, with the 980 grams of mixture forming the center layer. A hot-press, with platens heated to about 400 degrees Fahrenheit, applied a ram force of 10,000 pounds after a press-closing period of 30 seconds to the layered assembly. The assembly was pressed under these conditions for an additional period of 225 seconds. Following the hot pressing, a cold press with chiller fluid at approximately 45 degrees Fahrenheit applied a ram force of about 10,000 pounds to the layered assembly for about 225 seconds, reducing the core temperature of the layered assembly to about 194 degrees and pressing the layered assembly to a thickness to about 0.25 inches and a density of about 59 pounds per cubic foot.

Three replicate composite panels were prepared in this manner. A single test specimen (11.8-inch length×3.0-inch width) was isolated from each of the three composite panels. The resulting specimens, labeled K43-K45 in Tables 7 and 8 below, were humidified over a period of 744 hours, with the mass and length of the specimens measured periodically. Table 7 below shows the mass measurements for specimens K43-K45 at various times in the humidification process, as well as after the drying process. Table 8 below shows the length measurements for specimens K43-K45 at various times in the humidification process.

TABLE 7

| Conditioning | K43 | K44 | K45 |
|---|---|---|---|
| Time (h) @ 90% R.H. | Mass (g) | Mass (g) | Mass (g) |
| Dry | 134.7 | 135.0 | 134.9 |
| 0 | 139.0 | 139.1 | 139.2 |
| 4 | 140.2 | 140.1 | 140.2 |
| 24 | 141.3 | 141.4 | 141.6 |
| 48 | 142.0 | 142.1 | 142.5 |
| 168 | 144.6 | 144.3 | 144.9 |
| 192 | 144.8 | 144.7 | 145.2 |
| 216 | 145.2 | 144.7 | 145.5 |
| 336 | 146.3 | 145.8 | 146.4 |
| 384 | 146.8 | 146.2 | |
| 744 | 147.9 | 147.2 | 153.1 |

TABLE 8

| Conditioning | K43 Length | K44 Length | K45 Length |
|---|---|---|---|
| Time (h) @ 90% R.H. | (inch) | (inch) | (inch) |
| 0 | 11.8500 | 11.8482 | 11.8543 |
| 4 | 11.8440 | 11.8437 | 11.8483 |
| 24 | 11.8418 | 11.8393 | 11.8502 |
| 48 | 11.8433 | 11.8345 | 11.8490 |
| 168 | 11.8405 | 11.8290 | 11.8482 |
| 192 | 11.8378 | 11.8327 | 11.8447 |
| 216 | 11.8368 | 11.8282 | 11.8407 |
| 336 | 11.8302 | 11.8280 | 11.8398 |
| 384 | 11.8283 | 11.8250 | |
| 744 | 11.8262 | 11.8192 | 11.8198 |

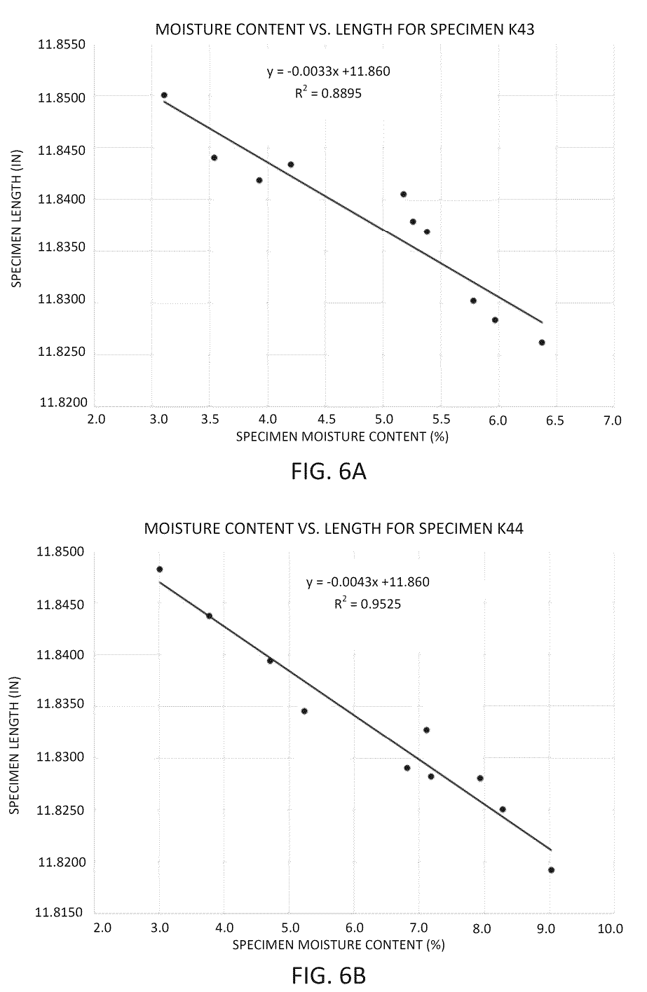

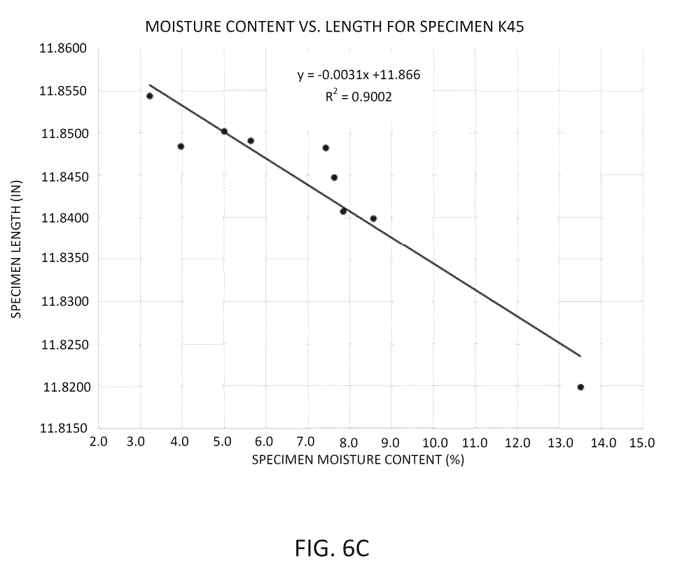

As described above, the moisture content of each specimen at each measurement was calculated by dividing the difference between the dry mass of the specimen and the measured mass at each time by the measured mass of the specimen. FIGS. 6A-6C are plots of the measured specimen length versus the determined moisture content at the same point in the humidification process for specimens K43-K45, respectively. As can be seen in FIGS. 6A-6C, the length measurement decreases with increasing moisture content. Thus, unlike typical building materials that swell when exposed to moisture, each of specimens 6A-6C reduced in length as the hydrophilic polymer fragments absorbed moisture and increasingly failed to resist the compressive stress in the hydrophobic, thermoplastic polymer elements. The relationship was similar for each of specimens K43-K45. The average relationship between moisture percentage and length in specimens K43-K45 had length decreasing by about 0.0036 inches per percent moisture increase. Thus, specimens K43-K45 exhibited similar levels of length contraction per unit of moisture content increase to that of the specimens examined in Example 3 but lower levels of length contraction per unit of moisture content increase than the specimens examined in Examples 1 and 2.

In an illustrative embodiment, any of the operations described herein can be implemented at least in part as computer-readable instructions stored on a computer-readable memory. Upon execution of the computer-readable instructions by a processor, the computer-readable instructions can cause a node to perform the operations.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “similar,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A composite comprising:
a discontinuous phase of dry, compressible, hydrophilic polymer elements; and
a continuous phase of hydrophobic thermoplastic polymer in a state of contractive stress.

2. The composite of claim 1, wherein the composite is configured to contract in one or more dimensions when subjected to a first hydration event.

3. The composite of claim 1, wherein the force required to compress the hydrophilic polymer elements in a wet state is less than 50 percent of the force to compress the hydrophilic polymer elements the same amount in a dry state.

4. The composite of claim 1, wherein the compressible, hydrophilic polymer elements are paper fragments with void space between the fibers in the paper.

5. The composite of claim 1, wherein the hydrophilic polymer elements have a porous structure.

6. The composite of claim 1, wherein the hydrophilic polymer elements comprise a foam.

7. The composite of claim 1, wherein the hydrophobic thermoplastic polymer comprises at least one of polyethylene, polypropylene, a copolymer of ethylene and propylene, a thermoplastic polyolefin (TPO), plasticized polyvinylchloride (PVC), styrene-butadiene resin (SBR), or polystyrene.

8. The composite of claim 1, wherein the hydrophobic thermoplastic polymer constitutes about 45 percent or more of the volume of the materials in the composite.

9. The composite of claim 1, further comprising one or more intractable sheets laminated to a core material comprising the compressible, hydrophilic polymer elements and the continuous hydrophobic thermoplastic polymer phase.

10. The composite of claim 9, wherein the one or more intractable sheets comprise paper, nonwoven fiberglass, cellulose, cellulose acetate, polyester, nylon, polycarbonate, polyetherimide, polyether ether ketone, polyaryl ether ketone, polyphenylene sulfide, or polysulfone.

11. A method for making a dry composite material that exhibits contraction in one or more dimensions when initially hydrated, the method comprising:
preparing a mixture of dry, compressible, hydrophilic polymer elements and hydrophobic thermoplastic polymer;
forming the mixture into a mat;
heating the mat to a temperature that is greater than the melting-point of the hydrophobic thermoplastic polymer such that the hydrophobic thermoplastic polymer melts and forms a continuous phase around the compressible, hydrophilic polymer elements;
molding the heated mat into a desired shape; and
cooling the mat to a temperature that is less than the congealing-point of the hydrophobic thermoplastic polymer.

12. The method of claim 11, wherein the hydrophilic polymer elements are fragments.

13. The method of claim 11, wherein the hydrophilic polymer elements are paper fragments.

14. The method of claim 11, wherein the hydrophilic polymer elements have a porous structure.

15. The method of claim 11, wherein the hydrophilic polymer elements are a type of foam.

16. The method of claim 11, wherein the hydrophobic thermoplastic polymer is polyethylene, polypropylene, a copolymer of ethylene and propylene, a thermoplastic polyolefin (TPO), plasticized polyvinylchloride (PVC), styrene-butadiene resin (SBR), or polystyrene.

17. The method of claim 11, wherein the hydrophobic thermoplastic polymer constitutes about 45 percent or more of the volume of the mixture.

18. The method of claim 11, further comprising placing one or more intractable sheets in contact with one or more surfaces of the mat before heating, and molding and cooling the mat such that the intractable sheet goods are incorporated into the finished composite.

19. The method of claim 18, wherein the one or more intractable sheets comprise paper, nonwoven fiberglass, cellulose, cellulose acetate, polyester, nylon, polycarbonate, polyetherimide, polyether ether ketone, polyaryl ether ketone, polyphenylene sulfide, or polysulfone.

20. A method of constructing a building or modifying an existing structure, the method comprising:
installing a dry composite into a structure, the composite comprising:
a discontinuous phase of dry, compressible, hydrophilic polymer elements; and
a continuous phase of hydrophobic thermoplastic polymer in a state of contractive stress; and
shrinking the composite in at least one dimension by exposing the composite to water for a first time.
